(19) United States
(12) Patent Application Publication
(10) Pub. No.: US 2026/0371357 A1
(43) Pub. Date: Nov. 19, 2026

(54) METHOD, DEVICE, AND SYSTEM FOR DCI AND PDCCH MAPPING IN WIRELESS NETWORKS

(71) Applicant: ZTE CORPORATION, Shenzhen, Guangdong (CN)

(72) Inventors: Xiangyang DUAN, Shenzhen (CN); Hanchao LIU, Shenzhen (CN); Feng XIE, Shenzhen (CN); Fei WANG, Shenzhen (CN)

(21) Appl. No.: 19/142,652

(22) PCT Filed: Feb. 8, 2023
(86) PCT No.: PCT/CN2023/075072

§ 371 Date: Jun. 24, 2025

(51) Int. Cl. H04W 72/232

(52) U.S. Cl. CPC H04W 72/232

(57) ABSTRACT

This disclosure relates generally to a method, device, and system for mapping, and transmission of Downlink Control Information (DCI) in a wireless network. One method performed by a wireless device is disclosed. The method may include: receiving, from a network node, a Downlink Control Information (DCI) mapping information associated with a Physical Downlink Control Channel (PDCCH) using a first Radio Access Technology (RAT), the DCI mapping information indicating RATs of DCIs assigned to be transmitted in the PDCCH, wherein at least one of the RATs is a second RAT different from the first RAT; and receiving a first set of DCIs in the PDCCH based on the DCI mapping information, wherein a RAT of at least one DCI in the first set of DCIs is different from the first RAT.

### TECHNICAL FIELD

This disclosure is directed generally to wireless communications, and particularly to a method, device, and system for mapping, and transmission of Downlink Control Information (DCI) in a wireless network.

### BACKGROUND

With the rapid evolution of wireless communication technology, and to satisfy the demand for higher speed, higher throughput and capacity, higher efficiency, and lower latency, new Radio Access Technologies (RATs) are emerging and commercialized rapidly. This may be represented by newer generation of wireless technologies. At the same time, the previous generation of RATs may still be employed to generate return on the investment as they still have the ability to undertake communication tasks and carry significant amount of traffic. It is critical to effectively utilize radio resources of different RATs in the wireless network.

### SUMMARY

This disclosure is directed to a method, device, and system for mapping, scheduling, and transmission of DCI in a wireless network.

In some embodiments, a method performed by a wireless device is disclosed. The method may include: receiving, from a network node, a Downlink Control Information (DCI) mapping information associated with a Physical Downlink Control Channel (PDCCH) using a first Radio Access Technology (RAT), the DCI mapping information indicating RATs of DCIs assigned to be transmitted in the PDCCH, wherein at least one of the RATs is a second RAT different from the first RAT; and receiving a first set of DCIs in the PDCCH based on the DCI mapping information, wherein a RAT of at least one DCI in the first set of DCIs is different from the first RAT.

In some embodiments, a method performed by a network node is disclosed. The method may include: transmitting, to a wireless device, a Downlink Control Information (DCI) mapping information associated with a Physical Downlink Control Channel (PDCCH) using a first Radio Access Technology (RAT), the DCI mapping information indicating RATs of DCIs assigned to be transmitted in the PDCCH, wherein at least one of the RATs is a second RAT different from the first RAT; and transmitting a first set of DCIs in the PDCCH based on the DCI mapping information, wherein a RAT of at least one DCI in the first list of DCIs is different from the first RAT.

In some embodiments, there is a wireless device or a network node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary dual connectivity configuration with one 4G connection and one 5G connection.

FIG. 5a shows an exemplary cross-RAT DCI mapping under a dual connectivity configuration with one 4G connection and one 5G connection.

FIG. 5b shows an exemplary cross-RAT DCI mapping under a tiple connectivity configuration with one 3G connection, one 4G connection, and one 5G connection.

FIG. 6 shows an exemplary Multi-RAT Dual connectivity configuration.

FIG. 7 shows an exemplary Inter-RAT Carrier Aggregation (Inter-RAT CA) configuration.

FIGS. 8a-8d show exemplary DCI ordering schemes when mapping DCIs to PDCCH.

FIG. 9 shows an exemplary method for wireless communication.

### DETAILED DESCRIPTION

### Wireless Communication Network

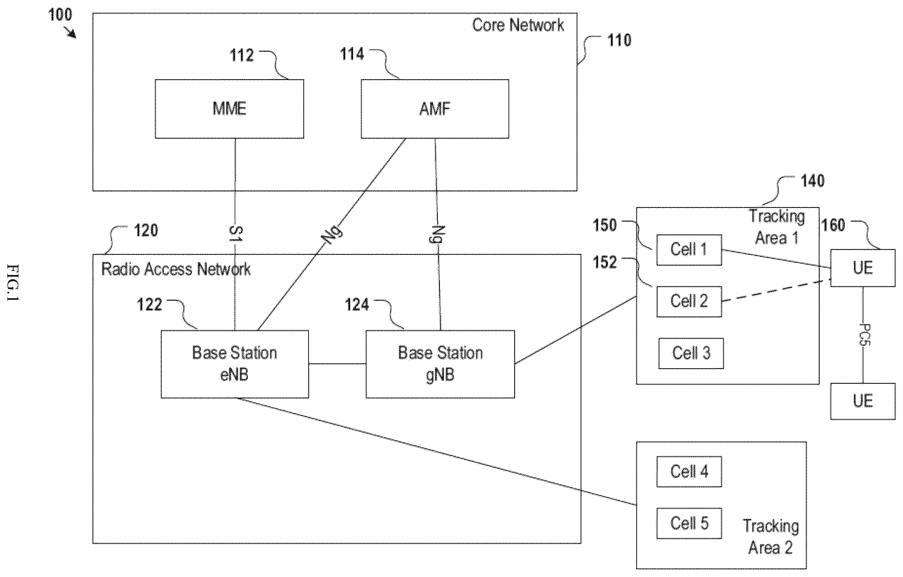

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

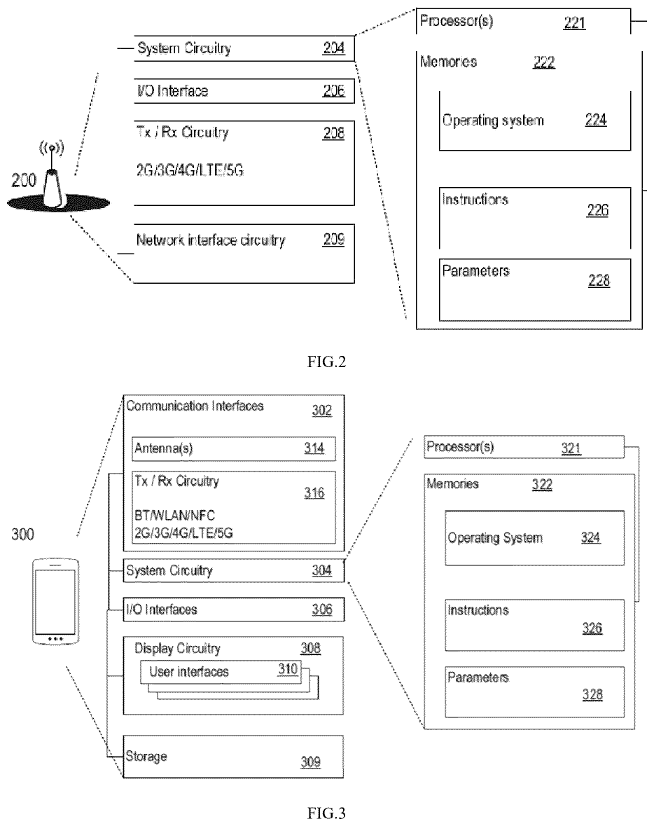

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

Network Deployment with Multiple RAT

With the rapid evolution of wireless communication technology, and to satisfy the demand for higher speed, higher throughput and capacity, higher efficiency, and lower latency, new Radio Access Technologies (RATs) are emerging and commercialized rapidly. This may be represented by newer generation of wireless technologies. At the same time, the previous generation of RATs may still be employed to generate return on the investment as they still have the ability to undertake communication tasks and carry significant amount of traffic. For example, in the initial stage of 5th generation (5G) mobile network deployment, a Non-Standalone (NSA) Architecture may be adopted. Under an example NSA architecture, an existing 4G core is used as an anchor point for the control signaling of a 5G Radio Access Network (RAN). That is, the 5G RAN is overlaid in an existing 4G core.

Multi-RAT networking has become an important networking scenario for wireless communications. For example, more RATs will participate in collaborative networking, and the networking scenarios will be more complex. In addition to Multi-RAT Dual connectivity (MRDC), there may be more other multi-RAT networking solutions in the development stage of mobile communication in the future, such as inter-RAT Carrier Aggregation (CA). Therefore, how to efficiently use different RAT resources is an issue that requires great attention now and in the future.

In wireless communication technology such as 5G technology, multiple different RATs may be deployed together to form a multi-RAT network. This type of deployment may also be referred to as a multi-RAT collaborative network. In general, a RAT defines underlying physical connection method, protocol, and specification for a radio-based communication network. The RAT may include cellular wireless technology in various generation, such as 5G New Radio (NR), 4G Long Term Evolution (LTE), Evolved UMTS Terrestrial Radio Access Network (E-UTRAN), Worldwide Interoperability for Microwave Access (WiMax), 3G Universal Mobile Telecommunications System (UMTS), 3G Code Division Multiple Access (CDMA), 2G Global System for Mobile Communications (GSM), etc. The RATs may further include non-cellular technologies, such as Wi-Fi, ZigBee, LoRa, Bluetooth, and the like.

In the multi-RAT network, connections may be established between the UE and the network based on two or more links using different RATs. In example implementations, each RAT link may connect to or terminate on a different network node (or network element, such as a base station) that is RAT specific. In other example implementations, each RAT link may connect to or terminate on a same network node that is capable of supporting multiple RATs. Each RAT link may have a downlink Physical Downlink Control Channel (PDCCH) which carries the Downlink Control Information (DCI) specific to the RAT associated with the link. The UE may receive DCIs of different RATs on these downlink PDCCHs. Specifically, due to different underlying technical specifications of the RATs (e.g., physical layer specifications), the UE may need to receive and process these DCIs following their corresponding RATs. More details will be described in sections below.

FIG. 4 shows an exemplary multi-RAT network deployment scenario. In FIG. 4, two connections (links) are established between the UE and the network side. Link 410 uses 4G RAT (or belongs to 4G RAT), and link 412 uses 5G RAT. The 4G and 5G RATs in this example are for exemplary purpose only. Alternatively and/or additionally, there may be links belonging to other RATs. Note that the network may include a Radio Access Network (RAN), which may include, for example, base stations of various generations of technologies. These base stations may terminate the links with the UE. In some implementations, each base station may correspond to a particular RAT. In some other implementations, one base station may support multiple RATs simultaneously.

The multi-RAT network deployment may include various scenarios, such as Multi-RAT Dual Connectivity (MRDC), Inter-RAT CA. MRDC refers to a range of different Dual Connectivity configuration options. In example implementations, under MR-DC, a Master RAN Node functions as the controlling entity, utilizing a Secondary RAN for additional data capacity. Example MR-DC configurations include EN-DC (E-UTRA-NR Dual Connectivity), NE-DC (NR-E-UTRA Dual Connectivity), NR-DC (New Radio Dual Connectivity), NGEN-DC (NG-E-UTRA-NR Dual Connectivity), etc. Under Inter-RAT CA, multiple connections between UE and network may be established using multiple carriers belonging to different RATs. For example, these carriers may belong to a Primary cell (Pcell) and Secondary cells (Scells) using different RATs; or these carriers may belong to Scells using different RATs.

In some example implementations, the multi-RAT collaborative networks may be formed by 4G E-UTRAN and 5G NR. In particular, as the uplink and downlink waveform format for 4G E-UTRAN and 5G NR are both based on Orthogonal Frequency Division Multiplexing (OFDM) and Single-Carrier FDMA (SC-FDMA), there is special benefit for collaborative networking between the two.

In order to support uplink and downlink data transmission, in wireless communication, such as cellular mobile communication, various downlink control signaling and downlink physical control channels are provided. For example, the downlink physical control channels of 4G E-UTRAN include Physical Control Format Indicator Channel (PCFICH), Physical Hybrid ARQ Indicator Channel (PHICH) and Physical Downlink Control Channel (PDCCH), etc. In 5G NR, there is PDCCH.

In example implementations, the PDCCH may be used for transmitting Downlink Control Information (DCI). The DCI may be the mapped to and carried in the PDCCH for transmission. In 4G technology such as LTE, the DCI is typically used for downlink resource assignment (DL assignment) and uplink resource grant (UL grant). Similarly, in 5G NR, the DCI is also used for DL assignment and UL grant. In addition, the DCI in 5G may also be used for indicating uplink and downlink symbol information, slot format indication, preemption indication, and power control.

There are various DCI formats, and different DCI formats correspond to different purposes. For example, in 4G, DCI format 0 and DCI format 4 are used for UL grant; DCI format 1/1A/1B/1C/1D/2/2A/2B/2C is used for DL assignment. In 5G, DCI format 0-0 and DCI format 0-1 are used for UL grant; DCI format 1-0 and DCI format 1-1 are used for DL assignment; DCI format 2-0 is used for slot format indicator (SFI); DCI format 2-1 is used for preemption indication; DCI format 2-2 is used for transmitting power control commands of UL grant and DL assignment; DCI format 2-3 is used for power control commands of uplink Sounding Reference Signal (SRS) transmission.

Each RAT may have its corresponding DCIs and DCIs may be categorized by the corresponding RATs. For example, there may exist: DCIs for 5G NR RAT (i.e., 5G NR RAT DCIs, or 5G RAT DCIs); DCIs for 4G LTE (i.e., 4G LTE RAT DCIs, or 4G RAT DCIs); DCIs for 3G UMTS (i.e., 3G UMTS RAT DCIs, or 3G RAT DCIs); DCIs for Wi-Fi (i.e., Wi-Fi RAT DCIs); DCIs for Bluetooth (i.e., Bluetooth RAT DCIs), and the like. Each type of DCI corresponds to and is used to support its corresponding RAT. In this disclosure, a DCI for a RAT may be referred to as DCI belonging to the RAT.

In existing mobile communication technology, the DCI for a RAT can only be carried in the PDCCH of the same RAT for transmission. That is, the RAT of the DCI and the RAT of the PDCCH need to match. For example, a DCI for 4G LTE (i.e., a 4G LTE RAT DCI) can only be carried in the PDCCH of 4G LTE RAT for transmission; a DCI for 5G NR can only be carried in the PDCCH of the 5G NR RAT for transmission. Although the DCI for one carrier may be carried in the PDCCH of another carrier for transmission, that is, the DCI transmission is cross-carrier, these two carriers still belong to the same RAT. For example, the PDCCH of a 5G NR Primary cell (Pcell) may carry a DCI for the 5G NR Secondary cell (Scell), however, the DCI RAT of the DCI (or RAT of the DCI for simplicity) is still 5G NR, that is, the RAT of the DCI and the RAT of the PDCCH are still the same.

In existing mobile communication technology, in a multi-RAT network deployment scenario, two or more different RAT links may be established between the UE and the network, and each RAT link may include a corresponding PDCCH of the same RAT. The DCI for each RAT can only be carried in the PDCCH of the same RAT for transmission. For example, as shown in FIG. 4, a 4G link 410 and a 5G link 412 are established between the UE and the network. Exemplarily, in this disclosure, a link between the UE and the network may be bi-directional and may include a PDCCH (for downlink) and a PUCCH (for uplink). The DCI for 4G RAT (4G DCI) can only be carried in the PDCCH of a same 4G RAT for transmission; whereas the DCI for 5G NR (5G NR DCI) can only be carried in the PDCCH of the same 5G NR RAT for transmission. Note that the network may include a Radio Access Network (RAN), which may include, for example, base stations of various generations of technologies. These base stations may terminate the links with the UE.

It is observed that each RAT may have its own corresponding frequency point and the frequency points for these RATs are different. A downlink with a higher frequency point tends to have limited or smaller coverage compared with a downlink with a lower frequency point. At a high frequency, the path loss is large, and so is the energy attenuation of the electromagnetic wave during the air interface propagation process, resulting in weak signal strength received by the UE side. This leads to a low Signal to Interference and Noise Ratio (SINR) at the UE side, and may seriously impact the signal demodulation of the UE. When the channel quality of one or more downlink RAT links is degraded, the UE may not be able to receive (e.g., demodulate, decode) the DCIs for the corresponding RATs correctly, causing degradation and/or interruption of data transmission.

In order to solve the aforementioned problems, in this disclosure, various cross-RAT DCI mapping methods are disclosed, such that DCI for one RAT (DCI belonging to one RAT) may be mapped to a PDCCH of a different RAT for transmission. The methods are discussed in great details in sections below.

### Cross-RAT DCI Mapping and Transmission

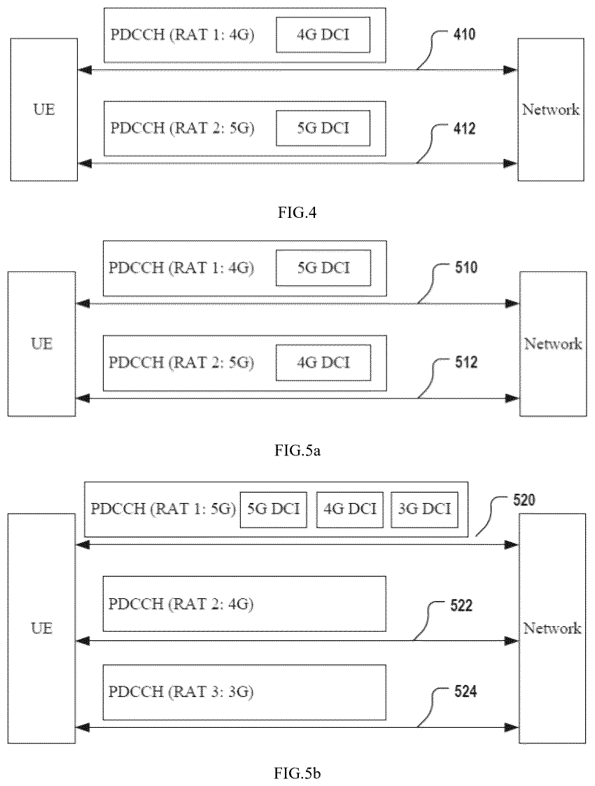

Referring to FIG. 5a, in a multi-RAT network deployment scenario, two or more connections, also referred to as RAT links (e.g., 510 and 512), may be established between the UE and the network side. The DCI for one RAT may be mapped to and carried in the PDCCH of one or more other RATs for transmission. For example, link 510 uses 4G RAT, and link 512 uses 5G RAT. A DCI for 5G NR (5G DCI) can be mapped to and carried in the PDCCH of the 4G link 510 for transmission. Similarly, a DCI for 4G (4G DCI) can be mapped to and carried in the PDCCH of the 5G NR link 512 for transmission.

As another example, link of other RAT, such as a link of 3G UMTS may also exist. As shown in FIG. 5b, there are 3 RAT links: a 5G RAT link 520, a 4G RAT link 522, and a 3G RAT link 524. Exemplarily, DCIs for all the RATs (5G, 4G, and 3G DCIs) are mapped to and carried in the PDCCH of the 5G link 520 for transmission.

In example implementations, when the channel quality of one or more downlink RAT links (but not all RAT links) between the UE and the network side is degraded (e.g., SINR is below a threshold), the DCIs for these RATs may be carried in the PDCCH(s) of other RAT(s) for transmission, for example, if channel quality of these PDCCHs is good (e.g., channel quality is above a threshold). For example, referring back to FIG. 5b, when the 3G and 4G downlink channel qualitys are degraded and the 5G downlink channel quality is good, the 3G DCIs and 4G DCIs may be mapped to and carried on the 5G PDCCH for transmission. For another example, when the 4G downlink channel quality is degraded and the 5G downlink channel quality is good, the 4G DCI can be mapped to and carried on the 5G PDCCH for transmission.

In this disclosure, various embodiments are described, aiming for at least solving the technical issue of DCI transmission failure due to degraded channel quality in a multi-RAT collaborative networking environment. These embodiments may utilize cross-RAT DCI mapping, that is, DCI for one RAT (or DCI belonging to one RAT) may be mapped to and transmitted in a PDCCH of a different RAT.

In this disclosure, for ease of description, a DCI RAT is used to refer to the RAT that the DCI applies to, belongs to, or serves. For example, a 5G RAT DCI (or 5G DCI for simplicity) refers to a DCI applies to 5G RAT.

In this disclosure, for ease of description, DCI RAT is used to refer to a RAT to which the DCI applies or belongs to. For example, 5G RAT DCI (or 5G DCI for short) refers to the DCI applicable to 5G RAT. Similarly, PDCCH RAT is used to refer to a RAT to which the PDCCH belongs, or a RAT the PDCCH uses. For example, there may be 3G PDCCH for a PDCCH belonging to 3G, 4G PDCCH for a PDCCH belonging to 4G, and 5G PDCCH for a PDCCH belonging to 5G.

Details on these embodiments are described below.

### Embodiment 1: Cross-RAT DCI Mapping in MRDC

In a wireless communication network, an MRDC (Multi-RAT Dual Connectivity) networking may be employed.

In example implementations, a UE may be configured with a Master Cell Group (MCG) and a Secondary Cell Group (SCG). The MCG and the SCG belong to different RATs.

The MRDC may include following configurations:
EN-DC (E-UTRA-NR Dual Connectivity)
NR-DC (New Radio Dual Connectivity)
NGEN-DC (NG-E-UTRA-NR Dual Connectivity)
NE-DC (NR-E-UTRA Dual Connectivity)

The MCG may include a group of serving cells associated with the Master Node, including a Pcell and optionally one or more Scells. The SCG may include a group of serving cells associated with the Secondary Node, including a Primary SCG Cell (PScell) and optionally one or more Scells.

The MCG and the SCG may each have its own DCI (MCG DCI or SCG DCI). In this embodiment, the MCG DCI may be carried in the PDCCH of the SCG, for example, the PDCCH of PScell or Scell of the SCG. Similarly, the SCG DCI may be carried in the PDCCH of the MCG, for example, the PDCCH of Pcell or Scell of the MCG.

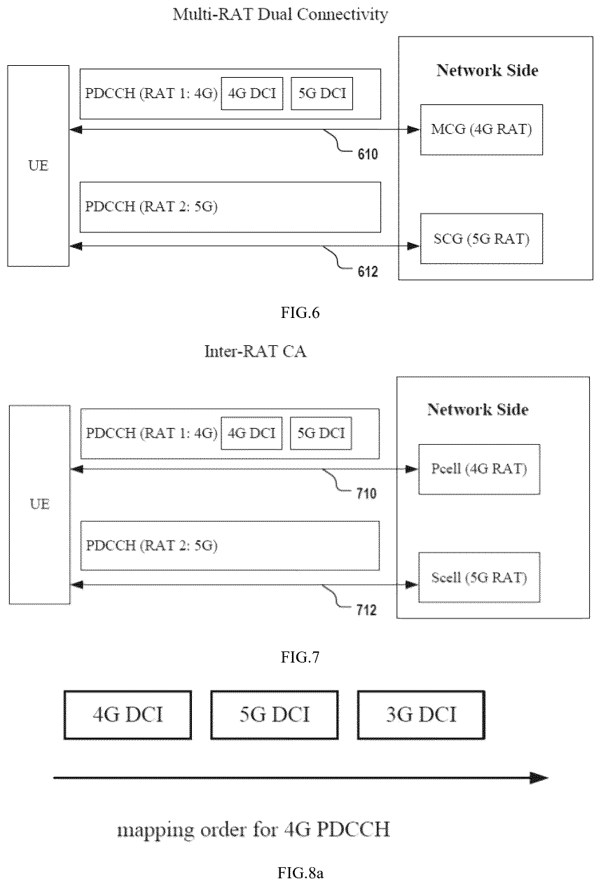

Referring to FIG. 6 for an exemplary MRDC deployment. In FIG. 6, the UE has dual connections (610 and 612) with the network. Specifically, UE is configured with connection 610 with the MCG (4G RAT) and connection 612 with the SCG (5G RAT).

An exemplary method according to this embodiment may include following steps:

### Step 1:

The UE receives configuration information from the network. The configuration information may include cross-RAT DCI mapping information indicating that DCIs for one or more RATs are mapped to and transmitted in a PDCCH of another RAT.

In one implementation, UE may receive the configuration information from a network node in the network, such as a base station.

For example, under the MRDC configuration, the cross-RAT DCI mapping information may include DCI RATs for DCIs that are assigned to be transmitted in a corresponding PDCCH (i.e., DCIs to be mapped to a PDCCH), as well as the PDCCH RAT for the corresponding PDCCH. Refer to Table 1 below for some exemplary cross-RAT DCI mapping information. In Table 1, each row represents a possible cross-RAT DCI mapping information.

TABLE 1
Cross-RAT DCI Mapping to PDCCH

| DCI RATs | PDCCH RAT | Note |
|---|---|---|
| {3G, 4G, 5G} | 5G | DCIs with DCI RATs belonging to {3G, 4G, |
| | | 5G} are mapped to and carried in a PDCCH |
| | | using 5G RAT. |
| {4G, 5G} | 4G | DCIs with DCI RATs belonging to {4G, 5G} |
| | | are mapped to carried in a PDCCH using 4G |
| | | RAT. |

Note that in Table 1, DCI RAT is indicated explicitly. Alternatively, other information may be used to implicitly indicate one or more DCI RATs. In some example implementations, there is a mapping relationship between a cell and a RAT (i.e., the cell uses or belong to the specific RAT). A cell identifier (ID or id) may be employed to implicitly indicate the DCI RAT. For example, a cell with cell id 100 is a 4G cell, and a cell with cell id 200 is a 5G cell, then instead of using {4G, 5G} to represent the DCI RATs, {cell id 100, cell id 200} may be used. Further note that by using a cell id, such as cell id 100, a further restriction may be added, such that only DCIs belong to cell id 100 is to be mapped. In some other example implementations, a DCI RAT may be represented by using a combination of RAT and a cell identifier. For example, the DCI RATs may be indicated as: {(3G, cell id 100), (4G, cell id 200)}. Under this representation, 3G DCIs belong to cell id 100, and 4G DCIs belong to cell id 200 are to be mapped.

Note that in Table 1, PDCCH RAT is indicated explicitly in the cross-RAT DCI mapping information. Alternatively, other information may be used to implicitly indicate PDCCH of a certain RAT. In some example implementations, a cell group (e.g., MCG, or SCG, see further details below) may be used. Based on such information, the UE may be able to determine the particular PDCCH among multiple PDCCHs, and use the particular PDCCH to receive DCIs mapped therein. In some example implementations, a cell id may be used to indicate the PDCCH (and its RAT) associated with the cell identified by the cell id.

For another example, under the MRDC configuration, the cross-RAT DCI mapping information may include cell group(s) for DCIs that are assigned to be transmitted in a corresponding PDCCH, as well as the PDCCH RAT (or PDCCH cell group) for the corresponding PDCCH. Refer to Table 2 below for some exemplary cross-RAT DCI mapping information. Exemplarily, the RATs of the MCG and the SCG are 5G and 4G, respectively. In Table 2, each row represents a possible cross-RAT DCI mapping information.

TABLE 2
Cross-RAT DCI Mapping to PDCCH

| Cell Group of DCI | Cell Group of PDCCH | Note |
|---|---|---|
| {MCG, SCG} | SCG | DCIs for cell group {MCG, SCG} are |
| | | carried in a PDCCH of the SCG. |
| {MCG} | SCG | DCIs for cell group {MCG} are carried |
| | | in a PDCCH of the SCG. |
| {SCG} | MCG | DCIs for cell group {SCG} are carried |
| | | in a PDCCH of the MCG. |

The configuration information may be sent from the network to the UE via a Radio Resource Control (RRC) message, or a System Information message. Exemplarily, the configuration information may be carried in an Information Element (IE) of the RRC message, such as a PDCCH configuration IE (PDCCH-Config IE), PDCCH configuration common IE (PDCCH-ConfigCommon IE), a PDCCH configuration System Information Block (PDCCH-ConfigSIB1 IE), and the like.

The RRC message may include: an RRCReconfiguration message; an RRCSetup message, and an RRCResume message.

A UE may receive the configuration information when it is in various states. For example, a UE in idle state may receive the configuration information via an RRCSetup message when the UE attempts to access/connect to the Master Node (MN) in the MCG; a UE in inactive state may receive the configuration information via an RRCResume message when the UE is woken up by the Master Node; or a UE in connected state may receive the configuration information via an RRCReconfiguration message when certain configuration, such as Master Node configuration, is re-configured.

Referring to FIG. 6, the UE may receive configuration information indicating that DCIs belonging to both 4G RAT and 5G RAT are mapping into and carried on a 4G PDCCH. Note that the 4G PDCCH is supported by the MCG via link 610. Further note that in this scenario, the 5G PDCCH supported by the SCG via link 612 does not carry any DCI.

Aforementioned cross-RAT DCI mapping information is only for exemplary purpose. Note that the cross-RAT DCI mapping information may be presented in various forms not explicitly described above, as far as the UE may determine the DCI to PDCCH mapping, or more specifically, DCI RATs to PDCCH mapping. Exemplarily, the DCI RATS may apply to DCIs belonging to one or more cells, or DCIs belonging to one or more cell groups.

### Step 2:

UE receives DCIs belonging to various RATs (e.g., 3G, 4G, and 5G) or various cell groups (e.g., MCG, or SCG) from designated PDCCH based on the configuration information received in step 1.

Based on the configuration information, the UE may determine the DCI to PDCCH mapping information.

In some example implementations, UE may determine DCIs belonging to certain cell groups, or belonging to certain RATs are mapped to a PDCCH of a particular cell group or a particular RAT.

As an example, UE may determine that DCIs belonging to SCG are mapped into and carried in a PDCCH of the MCG. If the RAT of the MCG is 5G and the RAT of the SCG is 4G, then the UE will receive 4G DCIs on the 5G PDCCH supported by the MCG.

As another example, UE may determine that DCIs belonging to any one of MCG and SCG are mapped into and carried in a PDCCH of the SCG. If the RAT of the MCG is 5G and the RAT of the SCG is 4G, then the UE will receive 4G DCIs and 5G DCIs on the 4G PDCCH supported by the SCG.

As another example, UE may determine that DCIs belonging to 4G RAT are mapped into and carried in a PDCCH of the 5G RAT. If the RAT of the MCG is 5G and the RAT of the SCG is 4G, then the UE will receive 4G DCIs on the 5G PDCCH supported by the MCG.

As another example, UE may determine that DCIs belonging to any one of 4G RAT and 5G RAT are mapped into and carried in a PDCCH of the 4G RAT. If the RAT of the MCG is 5G and the RAT of the SCG is 4G, then the UE will receive 4G DCIs and 5G DCIs on the 4G PDCCH supported by the SCG.

As another example, UE may determine that DCIs belonging to cell with cell id 100 (3G RAT) is mapped to a 4G PDCCH; or UE may determine that DCIs belonging to one cell with cell id 100 (e.g., a 3G cell) is mapped to a 4G PDCCH in another cell with cell id 200 (e.g., a 4G cell).

Note that the UE receives (which includes decoding) the PDCCH following specification of the RAT to which the PDCCH belongs to.

In some example implementations, the UE may decode each DCI carried in the PDCCH based on the RAT of the each DCI (i.e., following the specification of the respective RAT). For example, if a PDCCH carries DCIs for 4G and 5G, then the UE may decode the 4G DCIs and 5G DCIs in accordance with the 4G RAT specification and 5G RAT specification, respectively.

### Embodiment 2: Cross-RAT DCI Mapping in Inter-RAT CA

In a wireless communication network, an Inter-RAT Carrier Aggregation (inter-RAT CA) networking may be employed.

Under the Inter-RAT CA, a UE may be configured with one Pcell and one or more Scells. Within component carriers (used for carrier aggregation), there are carriers belonging to different RATs. For example, the Pcell and the one or more Scell may correspond to different RATs; or one Scell and another Scell may correspond to different RATs.

In some example implementations, the Pcell may have its own DCI (Pcell DCI). The Pcell DCI belongs to the same RAT as the Pcell. On the Scell side, there may exist multiple scenarios. In one scenario, all the Scells share Scell DCIs, that is, Scell DCIs may apply to all the Scells. In another scenario, each Scell has its own Scell DCI. Scell DCIs belong to or apply to the same RAT as the Scell(s) they applies to.

Referring to FIG. 7 for an exemplary Inter-RAT CA networking. In FIG. 7, the UE has dual connections (710 and 712) with the network. Specifically, UE is configured with connection 710 with the Pcell (4G RAT) and connection 712 with the Scell (5G RAT).

In this embodiment, UE receives a PDCCH of the Pcell or a Scell, and the PDCCH may carry DCIs belonging to RAT(s). That is, DCIs for multiples cells (Pcells and/or Scells) and belonging to different RATs may be mapped into and carried in a same PDCCH. As an example, in FIG. 7, the PDCCH supported by the Pcell (4G RAT) carries DCIs for both the Pcell and the Scell, that is, the 4G PDCCH carries the 4G DCIs and 5G DCIs.

An exemplary method according to this embodiment may include following steps:

### Step 1:

The UE receives configuration information (or more specifically, cross-RAT DCI mapping configuration information) from the network. The configuration information may include cross-RAT DCI mapping information indicating that DCIs for one or more cells belonging to one or more RATs are mapped to and transmitted in a PDDCH of another cell belong to a RAT different from the one or more RATs.

In one implementation, UE may receive the configuration information from a network node in the network, such as a base station.

For example, under the Inter-RAT CA, the cross-RAT DCI mapping information may include DCI RATs for DCIs that are assigned to be transmitted in a corresponding PDCCH, as well as the PDCCH RAT for the corresponding PDCCH. Refer to Table 3 below for some exemplary cross-RAT DCI mapping information. In Table 3, each row represents a possible cross-RAT DCI mapping information.

TABLE 3
Cross-RAT DCI Mapping to PDCCH RAT

| DCI RATs | PDCCH RAT | Note |
|---|---|---|
| {3G, 4G, 5G} | 5G (Pcell) | DCIs with DCI RATs belonging to {3G, 4G, |
| | | 5G} are carried in a PDCCH of the Pcell |
| | | using 5G RAT. |
| {4G, 5G} | 4G (Scell) | DCIs with DCI RATs belonging to {4G, 5G} |
| | | are carried in a PDCCH of the Scell using 4G |
| | | RAT. Further note that an Scell ID may also |
| | | be included in the configuration information. |

Note that in Table 3, DCI RAT is indicated explicitly. Alternatively, other information may be used to implicitly indicate one or more DCI RATs. In some example implementations, there is a mapping relationship between a cell and a RAT (i.e., the cell uses or belong to the specific RAT). A cell identifier (ID, or id) may be employed to implicitly indicate the DCI RAT. For example, a cell with cell id 100 is a 4G cell, and a cell with cell id 200 is a 5G cell, then instead of using {4G, 5G} to represent the DCI RATs, {cell id 100, cell id 200} may be used. Further note that by using a cell id, such as cell id 100, a further restriction may be added, such that only DCIs belong to cell id 100 is to be mapped. In some other example implementations, a DCI RAT may be represented by using a combination of a RAT and a cell identifier. For example, the DCI RATs may be indicated as: {(3G, cell id 100), (4G, cell id 200)}. Under this representation, 3G DCIs belong to cell id 100, and 4G DCIs belong to cell id 200 are to be mapped.

Note that in Table 3, PDCCH RAT is indicated explicitly in the cross-RAT DCI mapping information. Alternatively, other information may be used to indirectly indicate PDCCH of a certain RAT. In some example implementations, a cell identifier identifying, for example, a Pcell, an Scell, or a PScell, may be used. Based on such information, the UE may be able to determine the particular PDCCH among multiple PDCCHs, and use the particular PDCCH to receive DCIs mapped therein.

For another example, under the Inter-RAT CA, the cross-RAT DCI mapping information may include cell(s) for DCIs that are assigned to be transmitted in a corresponding PDCCH, as well as the PDCCH RAT (or cell identity) for the corresponding PDCCH. Refer to Table 4 below for some exemplary cross-RAT DCI mapping information. Exemplarily, the RATs of the Pcell and the Scell are 5G and 4G, respectively. In Table 4, each row represents a possible cross-RAT DCI mapping information.

TABLE 4
Cross-RAT DCI Mapping to PDCCH RAT or Cell Identity

| | PDCCH RAT (or | |
|---|---|---|
| Cell Group of DCI | Cell Identity) | Note |
| {Pcell, Scell 1, | 5G (or Scell | DCIs for cells {Pcell, Scell 1, Scell 2} are inter- |
| Scell 2} | identified by cell | RAT DCIs and are carried in a 5G PDCCH, or |
| | id 3) | PDCCH supported by Scell 3. |
| {Scell 1} | 4G (or Scell | DCIs for cell {Scell 1} belongs to 5G RAT and are |
| | identified by cell | carried in a 4G PDCCH, or a PDCCH supported by |
| | id 2) | Scell 2. |
| {Scell 1} | 5G (or Pcell) | DCIs for cell {Scell 1} belongs to 4G RAT and are |
| | | carried in a 5G PDCCH, or a PDCCH supported by |
| | | Pcell. |

The configuration information may be sent from the network to the UE via a Radio Resource Control (RRC) message, or a System Information message. Exemplarily, the configuration information may be carried in an Information Element (IE) of the RRC message, such as a PDCCH configuration IE (PDCCH-Config IE), PDCCH configuration common IE (PDCCH-ConfigCommon IE), a PDCCH configuration System Information Block (PDCCH-ConfigSIB1 IE), and the like.

The RRC message may include: an RRCReconfiguration message; an RRCSetup message, and an RRCResume message. For example, UE may receive the RRCReconfiguration message including the configuration information when it attempts to add Scell.

### Step 2:

UE receives DCIs belonging to various RATs (e.g., 3G, 4G, and 5G) or various cells (e.g., Pcell, Scell(s)) on designated PDCCH based on the configuration information received in step 1.

Based on the configuration information, the UE may determine the DCI to PDCCH mapping information.

In some example implementations, UE may determine DCIs belonging to certain cells, or belonging to certain RATs are mapped to a PDCCH supported by a particular cell or a PDCCH belonging to a particular RAT.

In some example implementations, UE may determine DCIs belonging to certain carriers are mapped to a PDCCH supported by a particular carrier.

As an example, in an Inter-RAT CA deployment, the Pcell corresponds to 4G RAT, and Scell 1 corresponds to 5G RAT. Based on a received configuration information, UE may determine that DCIs belonging to 5G RAT (or DCIs belonging to Scell 1) are mapped into and carried in the PDCCH of the Pcell (note that the PDCCH belongs to 4G RAT).

As another example, in an Inter-RAT CA deployment, the Pcell corresponds to 4G RAT, and Scell 1 corresponds to 5G RAT. Based on a received configuration information, UE may determine that DCIs belonging to any one of 5G RAT and 4G RAT are mapped into and carried in a 4G PDCCH; or UE may determine that DCIs belonging to any one of Pcell and Scell 1 are mapped into and carried in the PDCCH of the Pcell.

Note that the UE receives the PDCCH following specification of the RAT to which the PDCCH belongs to.

In some example implementations, the UE may decode each DCI carried in the PDCCH based on the RAT of the each DCI (i.e., following the specification of the respective RAT).

### Embodiment 3: Cross-RAT DCI Mapping-DCI Processing

In this embodiment, DCIs belonging to one RAT may be mapped into and carried in a PDCCH belonging to a different RAT. In one implementation, a PDCCH belonging to one RAT may carry DCIs belonging to the same RAT and DCIs belonging to a different RAT. In one implementation, a PDCCH belonging to one RAT may only carry DCIs belonging to a different RAT.

When a DCI belonging to one RAT is carried in a PDCCH belonging to a different RAT, DCI processing may include, but not limited to: DCI format determination; DCI Information Element multiplexing; DCI formats determination, Information element multiplexing, Radio Network Temporary Identifier (RNTI) scrambling, cyclic redundancy check (CRC) calculation, channel coding, and rate matching. The DCI is processed according to the RAT specification corresponding to the DCI. For example, a 4G RAT DCI is processed according to its DCI RAT, which is 4G RAT.

When a DCI belonging to one RAT is carried in a PDCCH belonging to a different RAT, the PDCCH processing may include, but not limited to: Control Channel Element (CCE) related processing, Control Resource Set (CORESET) related processing, scrambling, modulation, and resource mapping. The PDCCH is processed according to the RAT specification corresponding to the PDCCH. For example, for a 5G RAT PDCCH carrying both 4G RAT DCIs and 5G RAT DCIs, the PDCCH is processed according to 5G RAT specification.

In some example implementations, a PDCCH of one RAT may carry DCIs of multiple RATs, and these DCIs may be processed jointly.

The joint processing of the DCIs of multiple RATs may include following steps:
1) The payload (e.g., Information Element) of the DCIs of multiple RATs are concatenated, to obtain a concatenated payload. The payload may include Information Elements of the DCIs, and the concatenated payload may be in the form of an Information Element sequence.
2) The concatenated payload sequence is processed or encoded, which may include at least one of: DCI format definition (e.g., adding a DCI format to each DCI), RNTI scrambling, CRC calculation, channel coding, and rate matching.

In some example implementations, a PDCCH of one RAT may carry DCIs of multiple RATs, and these DCIs may be processed individually.

The individual processing of the DCIs of multiple RATs may include following steps:
1) The payload (e.g., Information Element) of the DCIs of multiple RATs is individually processed or encoded, which may include at least one of: DCI format definition (e.g., adding a DCI format to each DCI), RNTI scrambling, CRC calculation, channel coding, and rate matching.
2) Map the individually processed or encoded DCI into the PDCCH.

A PDCCH of one RAT may carry DCIs of multiple RATs. When mapping these DCIs to the PDCCH, an ordering rule may be followed.

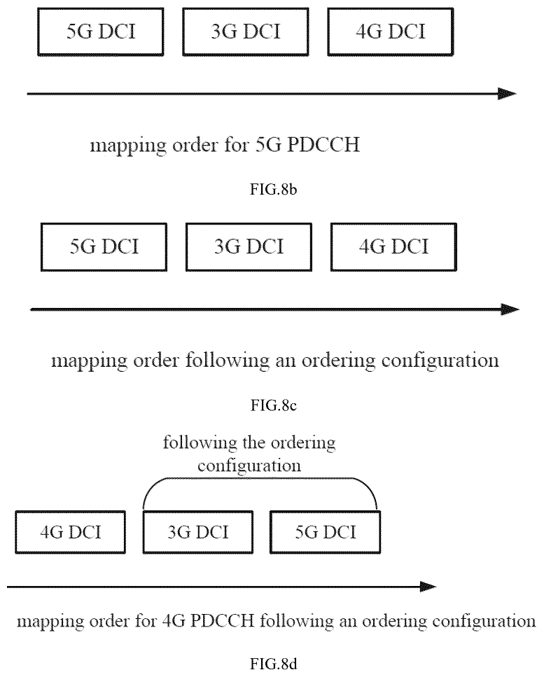

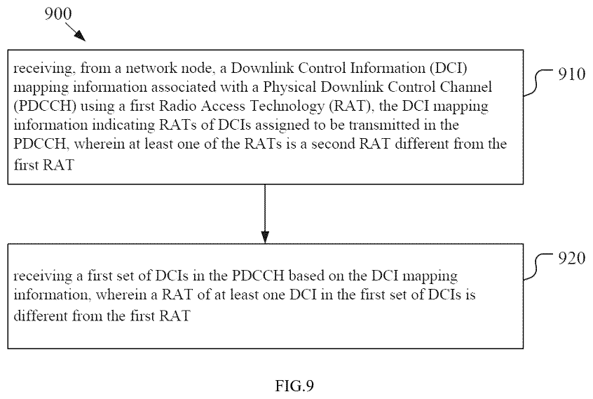

In some example implementations, the ordering rule may include: DCI belonging to a same RAT as the PDCCH is ordered before DCIs belonging to other RATs. Referring to FIG. 8a, the PDCCH is a 4G PDCCH, therefore, the 4G DCI is ordered before DCIs belong to other RATs. Referring to FIG. 8b, the PDCCH is a 5G PDCCH, therefore the 5G DCI is ordered before DCIs belong to other RATs.

In some example implementations, the ordering rule may include: ordering DCIs of different RATs based on an ordering configuration. The ordering configuration may be predefined, or transmitted to the UE from the network side. Referring to FIG. 8c, the ordering configuration may include: ordering the DCIs following this order: 5G, 3G, and 4G.

In some example implementations, the ordering rule may include: DCI belonging to a same RAT as the PDCCH is ordered before DCIs belonging to other RATs. Then DCIs belonging to other RATs are ordered based on an ordering configuration. The ordering configuration may be predefined, or transmitted to the UE from the network side. Referring to FIG. 8d, the PDCCH is a 4G PDCCH, so the 4G DCI is ordered before the rest of DCIs belonging to other RATs (i.e., 3G DCI and 5G DCI). Then the 3G DCI and the 5G DCI are order based on an ordering configuration which may include: ordering the DCIs following this order: 3G, then 5G.

In some example implementations, the cross-RAT DCI mapping feature may be enabled or disabled. For example, the network side may indicate to the UE whether the UE is expected to use a PDCCH of one RAT to carry DCI transmission of other RATs.

In some example implementations, the UE may report UE capability to the network side, indicating whether the UE supports the capability of receiving DCIs of one RAT on a PDCCH of other RATs.

### Embodiment 4: Information Elements for Supporting Cross-RAT DCI Mapping

In this embodiment, UE may receive configuration information from the network (or one or more network node such as a base station within the network). The configuration information may include cross-RAT DCI mapping information indicating that DCIs for at least one RAT are mapped to and transmitted in a PDDCH of another RAT. For example, referring back to FIG. 5b, the cross-RAT DCI mapping information may indicate that 4G DCIs and 3G DCIs are mapped to and transmitted in a 5G PDDCH. Note that the cross-RAT DCI mapping information does not exclude mapping for DCIs belonging to the same RAT as the PDCCH. For example, in FIG. 5b, the cross-RAT DCI mapping information may further indicate that 5G DCIs are mapped to and transmitted in a 5G PDCCH.

In example implementations, the configuration information may be carried in one or more IE of an RRC message, such as a PDCCH configuration IE (PDCCH-Config IE), a PDCCH configuration common IE (PDCCH-ConfigCommon IE), a PDCCH configuration System Information Block (PDCCH-ConfigSIB1 IE), and the like.

Exemplarily, the RRC IEs mentioned above are PDCCH specific. One RRC IE may be used to indicate a DCI RAT for DCIs that may be mapped to and transmitted in the PDCCH that the RRC IE applies to. This RRC IE may include at least one of: an enumerated field, such as “NR”; an integer, with each value represents a RAT, such as “1” representing NR and “2” representing 4G. Another RRC IE may be used to indicate the entity from which the DCI is sent. For example, this RRC IE may indicate cell ID of a cell (such as a Pcell, a Scell, or a PScell) to which the DCI with the particular DCI RAT belongs, or from which the DCI with the particular DCI RAT is sent. For another example, this RRC IE may indicate a cell group to which the DCI with the particular DCI RAT belongs, or from which the DCI with the particular DCI RAT is sent.

For example, the 4G RRC IE PDCCH-Config (applies to a 4G PDCCH) may include two RRC IEs. The first RRC IE is an enumerated field, and the field is set to “NR” or “5G”; the second RRC IE may include a ServCellIndex, and its value is 1. When the UE receives such configuration information, the UE may determine that the PDCCH on this 4G cell carries DCIs sent from or belong to the 5G cell with the cell index 1.

FIG. 9 shows an exemplary method 900 for wireless communication. The method may include a portion or all of the following step: step 910, receiving, from a network node, a Downlink Control Information (DCI) mapping information associated with a Physical Downlink Control Channel (PDCCH) using a first Radio Access Technology (RAT), the DCI mapping information indicating RATs of DCIs assigned to be transmitted in the PDCCH, wherein at least one of the RATs is a second RAT different from the first RAT; and step 920, receiving a first set of DCIs in the PDCCH based on the DCI mapping information, wherein a RAT of at least one DCI in the first set of DCIs is different from the first RAT.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a wireless device in a wireless network, comprising:
receiving, from a network node, a Downlink Control Information (DCI) mapping information associated with a Physical Downlink Control Channel (PDCCH) using a first Radio Access Technology (RAT), the DCI mapping information indicating RATs of DCIs assigned to be transmitted in the PDCCH, wherein at least one of the RATs is a second RAT different from the first RAT; and
receiving a first set of DCIs in the PDCCH based on the DCI mapping information, wherein a RAT of at least one DCI in the first set of DCIs is different from the first RAT.

2. The method of claim 1, wherein:
the DCI mapping information comprises a cell identifier of a cell belonging to a target RAT different from the first RAT, and
the DCI mapping information indicates that a DCI belonging to the cell is assigned to be transmitted in the PDCCH; or
the DCI mapping information comprises a combination of: a target RAT, and a cell identifier corresponding to the target RAT, the target RAT being different from the first RAT, and the DCI mapping information indicates that a DCI belonging to the target RAT for a cell identified by the cell identifier is assigned to be transmitted in the PDCCH.

3. (canceled)

4. The method of claim 1, wherein the first RAT comprises one of:
a second generation RAT comprising a Global System for Mobile Communications (GSM) RAT;
a third generation RAT comprising a Universal Mobile Telecommunications System (UMTS) RAT;
a fourth generation RAT comprising at least one of: a Long Term Evolution (LTE) RAT, or an Evolved UMTS Terrestrial Radio Access Network (E-UTRAN) RAT;
a Fifth Generation RAT comprising a New Radio (NR) RAT;
a Wi-Fi RAT;
a Bluetooth RAT; or
a ZigBee RAT.

5. The method of claim 1, wherein receiving the first set of DCIs in the PDCCH comprises:
decoding each DCI in the first set of DCIs based on its corresponding RAT.

6. The method of claim 1, wherein the first set of DCIs is mapped to the PDCCH by:
concatenating a payload of each DCI in the first set of DCIs to obtain an aggregated payload;
encoding the aggregated payload to obtain an encoded payload; and
mapping the encoded payload to the PDCCH.

7. The method of claim 1, wherein the first set of DCIs is mapped to the PDCCH by:
encoding a payload of each DCI in the first set of DCIs to obtain a corresponding encoded payload; and
individually mapping the encoded payload corresponding to the each DCI in the first set of DCIs to the PDCCH.

8. The method of claim 1, wherein:
DCIs in the first set of DCIs are mapped to the PDCCH following an order rule;
the ordering rule is based on RATs of the DCIs in the first set of DCIs; and
the ordering rule is pre-configured or sent to the wireless device from the wireless network;
wherein the ordering rule is characterized by:
DCI with the same RAT as the first RAT being preceding the DCIs with different RATs from the first RAT.

9. (canceled)

10. The method of claim 1, wherein receiving the first set of DCIs from the PDCCH comprises:
decoding the PDCCH to obtain a bitstream corresponding to the first set of DCIs; and
obtaining each DCI in the first set of DCIs from the bitstream, the each DCI in the first set of DCIs being arranged in the bitstream following an ordering rule;
wherein the bitstream comprises a first DCI with a RAT that is same as the first RAT, and a second set of DCIs with RATs different from the first RAT; and
the ordering rule is characterized by one of:
in the bitstream, the first DCI being preceding the second set of DCIs;
in the bitstream, all the DCIs being ordered based on a first ordering configuration; or
in the bitstream, the first DCI being preceding the second set of DCIs, and DCIs in the second set of DCIs being ordered by a RAT of each DCI in the second set of DCIs based on a second ordering configuration.

11. (canceled)

12. The method of claim 1, wherein the network node comprises a base station, the base station comprising one of:
a gNodeB (gNB);
an eNodeB (eNB);
an ng-eNodeB (ng-eNB); or
a NodeB.

13. A method for wireless communication, performed by a network node in a wireless network, comprising:
transmitting, to a wireless device, a Downlink Control Information (DCI) mapping information associated with a Physical Downlink Control Channel (PDCCH) using a first Radio Access Technology (RAT), the DCI mapping information indicating RATs of DCIs assigned to be transmitted in the PDCCH, wherein at least one of the RATs is a second RAT different from the first RAT; and
transmitting a first set of DCIs in the PDCCH based on the DCI mapping information, wherein a RAT of at least one DCI in the first set of DCIs is different from the first RAT.

14. The method of claim 13, wherein:
the DCI mapping information comprises a cell identifier of a cell belonging to a target RAT different from the first RAT, and
the DCI mapping information indicates that a DCI belonging to the cell is assigned to be transmitted in the PDCCH; or
the DCI mapping information comprises a combination of: a target RAT, and a cell identifier corresponding to the target RAT, the target RAT being different from the first RAT, and the DCI mapping information indicates that a DCI belonging to the target RAT for a cell identified by the cell identifier is transmitted in the PDCCH.

15. (canceled)

16. The method of claim 13, wherein the first RAT comprises one of:
a second generation RAT comprising a Global System for Mobile Communications (GSM) RAT;
a third generation RAT comprising a Universal Mobile Telecommunications System (UMTS) RAT;
a fourth generation RAT comprising at least one of: a Long Term Evolution (LTE) RAT, or an Evolved UMTS Terrestrial Radio Access Network (E-UTRAN) RAT;
a Fifth Generation RAT comprising a New Radio (NR) RAT;
a Wi-Fi RAT;
a Bluetooth RAT; or
a ZigBee RAT.

17. The method of claim 13, wherein transmitting the first set of DCIs in the PDCCH comprises:
encoding each DCI in the first set of DCIs based on its corresponding RAT.

18. The method of claim 13, wherein the first set of DCIs is mapped to the PDCCH by:
concatenating a payload of each DCI in the first set of DCIs to obtain an aggregated payload;
encoding the aggregated payload to obtain an encoded payload; and
mapping the encoded payload to the PDCCH.

19. The method of claim 13, wherein the first set of DCIs is mapped to the PDCCH by:
encoding a payload of each DCI in the first set of DCIs to obtain a corresponding encoded payload; and
individually mapping the encoded payload corresponding to the each DCI in the first set of DCIs to the PDCCH.

20. The method of claim 13, wherein:
DCIs in the first set of DCIs are mapped to the PDCCH following an order rule;
the ordering rule is based on RATs of the DCIs in the first set of DCIs; and
the ordering rule is pre-configured or sent to the wireless device from the wireless network;
wherein the ordering rule is characterized by:
DCI with the same RAT as the first RAT being preceding the DCIs with different RATs from the first RAT.

21. (canceled)

22. The method of claim 13, wherein transmitting the first set of DCIs in the PDCCH comprises:
encoding each DCI in the first set of DCIs following an ordering rule, to obtain a bitstream corresponding to the first set of DCIs; and
transmitting the bitstream in the PDCCH;
wherein the first set of DCIs comprises a first DCI with a RAT that is same as the first RAT, and a second set of DCIs with RATs different from the first RAT; and
the ordering rule is characterized by one of:
in the bitstream, the first DCI being preceding the second set of DCIs;
in the bitstream, all the DCIs being ordered based on a first ordering configuration; or
in the bitstream, the first DCI being preceding the second set of DCIs, and DCIs in the second set of DCIs being ordered by a RAT of each DCI in the second set of DCIs based on a second ordering configuration.

23. (canceled)

24. The method of claim 13, wherein the network node comprises a base station, the base station comprising one of:
a gNodeB (gNB);
an eNodeB (eNB);
an ng-eNodeB (ng-eNB); or
a NodeB.

25. A device or network node for wireless communication comprising a memory for storing computer instructions and a processor in communication with the memory, wherein, when the processor executes the computer instructions, the processor is configured to implement a method of claim 1.

26. A non-transitory computer program product comprising a non-transitory computer-readable program medium with computer code stored thereupon, the computer code, when executed by one or more processors, causing the one or more processors to implement a method of claim 1.
